(19) United States
(12) Patent Application Publication
(10) Pub. No.: US 2006/0064232 A1
(43) Pub. Date: Mar. 23, 2006

(54) System and method for controlling vehicle performance

(75) Inventors: Nathan D. Ampunan, West Bloomfield, MI (US); Richard Hart, Oakland Township, MI (US); Brent W. Fetherolf, Royal Oak, MI (US); Lynn A. Totten, Haslett, MI (US)

Correspondence Address: ANTHONY LUKE SIMON;General Motors Corporation, 300 Renaissance Center, Mail Code 482-C23-B21, P.O. Box 300, Detroit, MI, 48265-3000, US

(73) Assignee: General Motors Corporation

(21) Appl. No.: 10/948,687

(22) Filed: Sep. 23, 2004

(51) Int. Cl. G06F 19/00; B60T 7/16

(52) U.S. Cl. 701/115; 701/104; 180/167

(57) ABSTRACT

A system for implementing a method, as embodied in a computer usable medium, for controlling a performance of the vehicle. Weather data and a vehicle location is received. At least one ambient condition factor is determined based on the received weather data and vehicle location. At least one vehicle function is adjusted based on the determined at least one ambient condition factor.

### FIELD OF THE INVENTION

This invention relates generally to vehicles. More specifically, the invention relates to a strategy for controlling vehicle performance.

### BACKGROUND OF THE INVENTION

One of the fastest growing areas of communications technology is related to network solutions implemented within a vehicle such as an automobile. The demand and potential for wireless vehicle communication, networking, and diagnostics services have recently increased. Although many vehicles on the road today have limited wireless communication functions, such as unlocking a door and setting or disabling a car alarm, new vehicles offer additional communication systems that help personalize comfort settings, run maintenance and diagnostic functions, place telephone calls, access call center information, update controller systems, determine vehicle geographic position, retrieve current and forecast weather information, assist in tracking a vehicle after a theft of the vehicle, and provide other vehicle-related services. Such vehicle control and communications features may be orchestrated by a vehicle telematics unit, which is operably connected to various vehicle systems and to a call center through a wireless network.

Modern automobiles typically include means for controlling various vehicle functions. For example, an electronic control module (ECM), also known as the “brain-box,” may play a role in controlling virtually every automated vehicle function. The control of certain vehicle functions, in turn, may advantageously have a direct effect on vehicle performance including driver feel, fuel economy, engine temperature, engine speed, engine torque, engine horsepower, vehicle emissions, and the like. The ECM may include subsystems consisting of a central processing unit (CPU), a controller, various modules, and assorted signal inputs and outputs. The ECM is dedicated to controlling components within the vehicle that influence vehicle performance factors as well as other functions. For example, the ECM can manage engine functions, power-train functions, and exhaust recirculation. Other electronic modules may control antilock brake systems, etc. In many cases, these ECM subsystem modules communicate with each other through protocols such as controller-area networks (CAN), Society of Automotive Engineers (SAE) Standard J1850 for high-speed and lower speed applications, and other protocols known in the art.

It is understood that varying ambient conditions (e.g., temperature, barometric pressure, humidity, etc.) can have a significant effect on engine performance. Changes in temperature, barometric pressure, humidity, or combinations thereof may affect the performance characteristics of the engine. To monitor these conditions, the ECM typically includes an array of sensors. The ECM can utilize the information from these sensors, along with various algorithms and look-up tables, to maintain peak vehicle performance during changing conditions. For example, the ECM may adjust spark characteristics to compensate for changes in humidity. Although these sensors are invaluable for detecting the surrounding ambient conditions, they add to the cost and complexity of the vehicle. Therefore, it would be desirable to provide a strategy for monitoring surrounding ambient conditions of a vehicle and advantageously adjusting vehicle performance factors while eliminating one or more sensors.

### SUMMARY OF THE INVENTION

One form of the present invention is a method of controlling performance of a vehicle. The method includes receiving weather data and a vehicle location. At least one ambient condition factor is determined based on the received weather data and vehicle location. At least one vehicle function is adjusted based on the determined at least one ambient condition factor.

A second form of the invention is a computer usable medium including a program for controlling performance of a vehicle. The computer usable medium includes computer readable program code for receiving weather data, computer readable program code for receiving a vehicle location, and computer readable program code for determining at least one ambient condition factor based on the received weather data and vehicle location. The second form of the present invention further includes computer readable program code for adjusting at least one vehicle function based on the determined at least one ambient condition factor.

A third form of the present invention is a system for controlling at least one vehicle performance factor of a vehicle. The system includes means for receiving weather data, means for receiving a vehicle location, and means for determining at least one ambient condition factor based on the received weather data and vehicle location. The system further includes means for adjusting at least one vehicle function based on the determined at least one ambient condition factor.

The foregoing forms as well as other forms, features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

### BRIEF DESCRIPTION OF THE DRAWINGS

FIG. 1 is a schematic diagram of a mobile vehicle communication system in accordance with one embodiment of the present invention;

FIG. 2 is a schematic diagram of a system for controlling performance of a vehicle in accordance with one embodiment of the present invention;

FIG. 3 is a flow diagram of a method of controlling performance of a vehicle in accordance with one embodiment of the present invention; and

FIGS. 4A and 4B are exemplary weather matrices for temperature and humidity, respectively, each arranged by latitude and longitude.

### DETAILED DESCRIPTION OF THE DRAWINGS

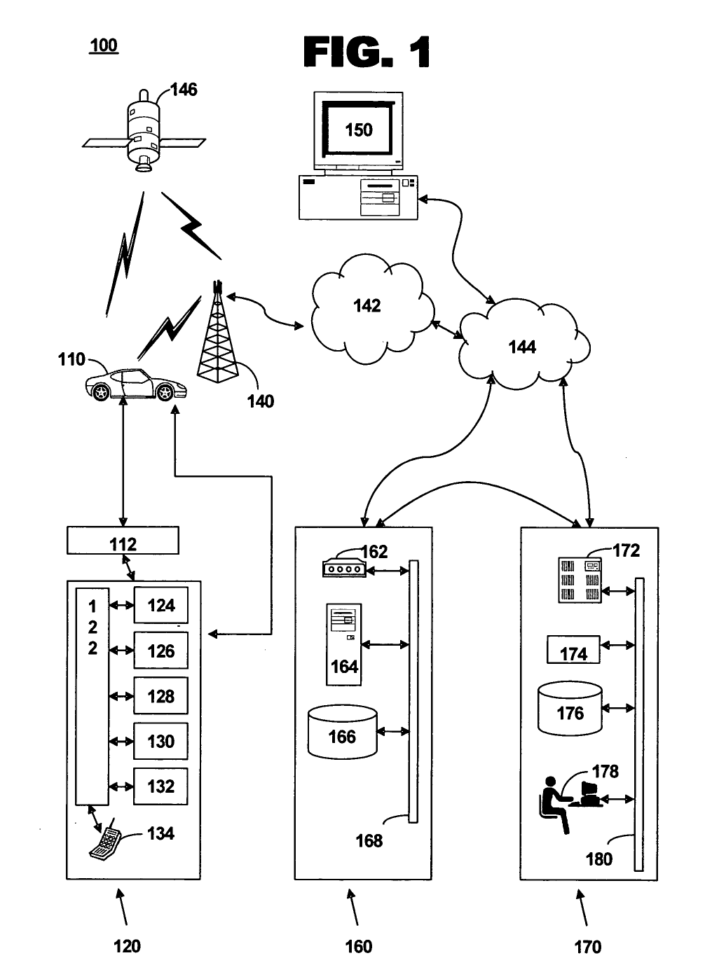

FIG. 1 is a schematic diagram of a mobile vehicle communication system in accordance with one embodiment of the present invention and shown generally by numeral 100. Mobile vehicle communication system (MVCS) 100 includes a mobile vehicle communication unit (MVCU) 110; a vehicle communication network 112; a telematics unit 120; one or more wireless carrier systems 140; one or more communication networks 142; one or more land networks 144; one or more satellite broadcast systems 146; one or more client, personal or user computers 150; one or more web-hosting portals 160; and one or more call centers 170. In one embodiment, MVCU 110 is implemented as a mobile vehicle equipped with suitable hardware and software for transmitting and receiving voice and data communications. MVCS 100 may include additional components not relevant to the present discussion. Mobile vehicle communication systems and telematics units are known in the art.

MVCU 110 is also referred to as a mobile vehicle in the discussion below. In operation, MVCU 110 may be implemented as a motor vehicle, a marine vehicle, or as an aircraft. MVCU 110 may include additional components not relevant to the present discussion.

MVCU 110, via a vehicle communication network 112, sends signals to various units of equipment and systems (detailed below) within MVCU 110 to perform various functions such as unlocking a door, opening the trunk, setting personal comfort settings, and calling from telematics unit 120. In facilitating interactions among the various communication and electronic modules, vehicle communication network 112 utilizes network interfaces such as controller-area network (CAN), International Organization for Standardization (ISO) Standard 9141, ISO Standard 11898 for high-speed applications, ISO Standard 11519 for 9141, ISO Standard 11898 for high-speed applications, ISO Standard 11519 for lower speed applications, and Society of Automotive Engineers (SAE) Standard J1850 for high-speed and lower speed applications.

MVCU 110, via telematics unit 120, sends to and receives radio transmissions from wireless carrier system 140. Wireless carrier system 140 is implemented as any suitable system for transmitting a signal from MVCU 110 to communication network 142.

Telematics unit 120 includes a processor 122 connected to a wireless modem 124, a global positioning system (GPS) unit 126, an in-vehicle memory 128, a microphone 130, one or more speakers 132, and an embedded or in-vehicle mobile phone 134. In other embodiments, telematics unit 120 may be implemented without one or more of the above listed components such as, for example, speakers 132. Telematics unit 120 may include additional components not relevant to the present discussion.

In one embodiment, processor 122 is implemented as a microcontroller, controller, host processor, or vehicle communications processor. In an example, processor 122 is implemented as an application specific integrated circuit (ASIC). In another embodiment, processor 122 is implemented as a processor working in conjunction with a central processing unit (CPU) performing the function of a general purpose processor. GPS unit 126 provides longitude and latitude coordinates of the vehicle responsive to a GPS broadcast signal received from one or more GPS satellite broadcast systems (not shown). In-vehicle mobile phone 134 is a cellular-type phone such as, for example a digital, dual-mode (e.g., analog and digital), dual-band, multi-mode or multi-band cellular phone.

Processor 122 executes various computer programs that control programming and operational modes of electronic and mechanical systems within MVCU 110. Processor 122 controls communications (e.g., call signals) between telematics unit 120, wireless carrier system 140, and call center 170. Additionally, processor 122 controls reception of communications from satellite broadcast system 146. In one embodiment, a voice-recognition application is installed in processor 122 that can translate human voice input through microphone 130 to digital signals. Processor 122 generates and accepts digital signals transmitted between telematics unit 120 and a vehicle communication network 112 that is connected to various electronic modules in the vehicle. In one embodiment, these digital signals activate the programming mode and operation modes, as well as provide for data transfers such as, for example, data over voice channel communication. In this embodiment, signals from processor 122 are translated into voice messages and sent out through speaker 132.

Wireless carrier system 140 is a wireless communications carrier or a mobile telephone system and transmits to and receives signals from one or more MVCU 110. Wireless carrier system 140 incorporates any type of telecommunications in which electromagnetic waves carry signal over part of or the entire communication path. In one embodiment, wireless carrier system 140 is implemented as any type of broadcast communication in addition to satellite broadcast system 146. In another embodiment, wireless carrier system 140 provides broadcast communication to satellite broadcast system 146 for download to MVCU 110. In an example, wireless carrier system 140 connects communication network 142 to land network 144 directly. In another example, wireless carrier system 140 connects communication network 142 to land network 144 indirectly via satellite broadcast system 146.

Satellite broadcast system 146 transmits radio signals to telematics unit 120 within MVCU 110. In one embodiment, satellite broadcast system 146 may broadcast over a spectrum in the “S” band (2.3 GHz) that has been allocated by the U.S. Federal Communications Commission (FCC) for nationwide broadcasting of satellite-based Digital Audio Radio Service (DARS).

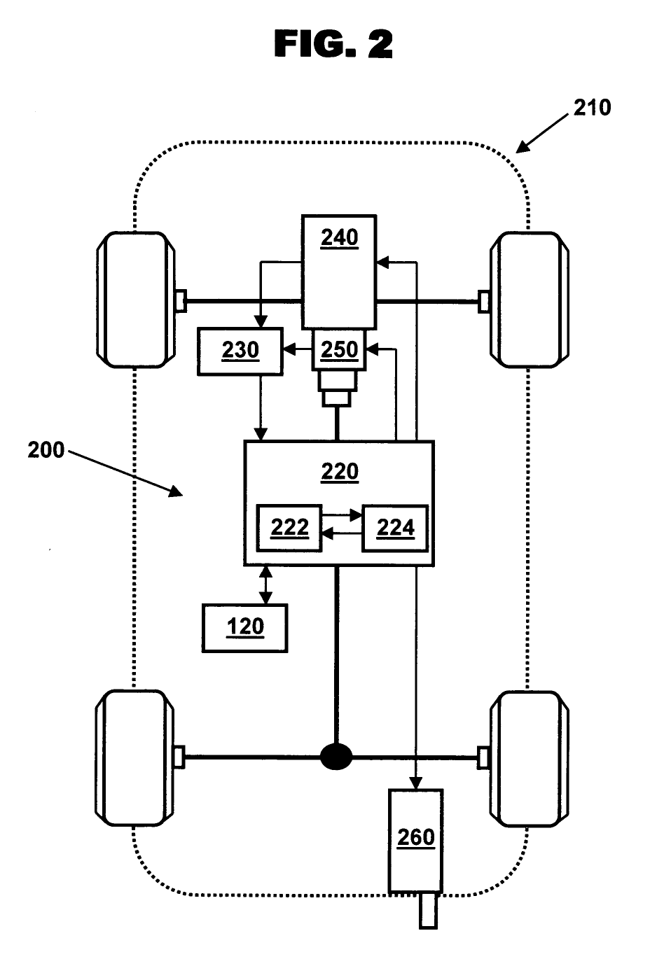

In operation, broadcast services provided by satellite broadcast system 146 are received by telematics unit 120 located within MVCU 110. In one embodiment, broadcast services include various formatted programs based on a package subscription obtained by the user and managed by telematics unit 120. In another embodiment, broadcast services include various formatted data packets based on a package subscription obtained by the user and managed by call center 170. In an example, data packets received by telematics unit 120 are implemented by processor 122. In another example, data packets received by telematics unit 120 are communicated (see FIG. 2 and discussion, below) to modified MVCUs within the MVCS.

Communication network 142 includes services from one or more mobile telephone switching offices and wireless networks. Communication network 142 connects wireless carrier system 140 to land network 144. Communication network 142 is implemented as any suitable system or collection of systems for connecting wireless carrier system 140 to MVCU 110 and land network 144.

Land network 144 connects communication network 142 to client computer 150, web-hosting portal 160, and call center 170. In one embodiment, land network 144 is a public-switched telephone network (PSTN). In another embodiment, land network 144 is implemented as an Internet protocol (IP) network. In other embodiments, land network 144 is implemented as a wired network, an optical network, a fiber network, other wireless networks, or any combination thereof. Land network 144 is connected to one or more landline telephones. Communication network 142 and land network 144 connect wireless carrier system 140 to web-hosting portal 160 and call center 170.

Client, personal, or user computer 150 includes a computer usable medium to execute Internet browser and Internet-access computer programs for sending and receiving data over land network 144 and, optionally, wired or wireless communication networks 142 to web-hosting portal 160. Computer 150 sends user preferences to web-hosting portal 160 through a web-page interface using communication standards such as hypertext transport protocol (HTTP), and transport-control protocol and Internet protocol (TCP/IP). In one embodiment, the data includes directives to change certain programming and operational modes of electronic and mechanical systems within MVCU 110.

In operation, a client utilizes computer 150 to initiate setting or re-setting of user preferences for MVCU 110. In an example, a client utilizes computer 150 to provide radio station presets as user preferences for MVCU 110. User-preference data from client-side software is transmitted to server-side software of web-hosting portal 160. In an example, user-preference data is stored at web-hosting portal 160.

Web-hosting portal 160 includes one or more data modems 162, one or more web servers 164, one or more databases 166, and a network system 168. Web-hosting portal 160 is connected directly by wire to call center 170, or connected by phone lines to land network 144, which is connected to call center 170. In an example, web-hosting portal 160 is connected to call center 170 utilizing an IP network. In this example, both components, web-hosting portal 160 and call center 170, are connected to land network 144 utilizing the IP network. In another example, web-hosting portal 160 is connected to land network 144 by one or more data modems 162. Land network 144 transmits digital data to and from modem 162, data that is then transferred to web server 164. In one embodiment, modem 162 resides inside web server 164. Land network 144 transmits data communications between web-hosting portal 160 and call center 170.

Web server 164 receives user-preference data from computer 150 via land network 144. In alternative embodiments, computer 150 includes a wireless modem to send data to web-hosting portal 160 through a wireless communication network 142 and a land network 144. Data is received by land network 144 and sent to one or more web servers 164. In one embodiment, web server 164 is implemented as any suitable hardware and software capable of providing web services to help change and transmit personal preference settings from a client at computer 150 to telematics unit 120 in MVCU 110. Web server 164 sends to or receives from one or more databases 166 data transmissions via network system 168. Web server 164 includes computer applications and files for managing and storing personalization settings supplied by the client, such as door lock/unlock behavior, radio station preset selections, climate controls, custom button configurations, and theft alarm settings. For each client, the web server potentially stores hundreds of preferences for wireless vehicle communication, networking, maintenance, and diagnostic services for a mobile vehicle.

In one embodiment, one or more web servers 164 are networked via network system 168 to distribute user-preference data among its network components such as database 166. In an example, database 166 is a part of or a separate computer from web server 164. Web server 164 sends data transmissions with user preferences to call center 170 through land network 144.

Call center 170 is a location where many calls are received and serviced at the same time, or where many calls are sent at the same time. In one embodiment, the call center is a telematics call center, facilitating communications to and from telematics unit 120 in MVCU 110. In another embodiment, the call center is a voice call center, providing verbal communications between an advisor in the call center and a subscriber in a mobile vehicle. In yet another embodiment, the call center contains each of these functions. In other embodiments, call center 170 and web-hosting portal 160 are located in the same or different facilities.

Call center 170 contains one or more voice and data switches 172, one or more communication services managers 174, one or more communication services databases 176, one or more communication services advisors 178, and one or more network systems 180.

Switch 172 of call center 170 connects to land network 144. Switch 172 transmits voice or data transmissions from call center 170, and receives voice or data transmissions from telematics unit 120 in MVCU 110 through wireless carrier system 140, communication network 142, and land network 144. Switch 172 receives data transmissions from and sends data transmissions to one or more web-hosting portals 160. Switch 172 receives data transmissions from or sends data transmissions to one or more communication services managers 174 via one or more network systems 180.

Communication services manager 174 is any suitable hardware and software capable of providing requested communication services to telematics unit 120 in MVCU 110. Communication services manager 174 sends to or receives from one or more communication services databases 176 data transmissions via network system 180. Communication services manager 174 sends to or receives from one or more communication services advisors 178 data transmissions via network system 180. Communication services database 176 sends to or receives from communication services advisor 178 data transmissions via network system 180. Communication services advisor 178 receives from or sends to switch 172 voice or data transmissions.

Communication services manager 174 provides one or more of a variety of services including initiating data over voice channel wireless communication, enrollment services, navigation assistance, directory assistance, roadside assistance, business or residential assistance, information services assistance, emergency assistance, and communications assistance. Communication services manager 174 receives service-preference requests for a variety of services from the client via computer 150, web-hosting portal 160, and land network 144. Communication services manager 174 transmits user-preference and other data such as, for example, primary diagnostic script to telematics unit 120 in MVCU 110 through wireless carrier system 140, communication network 142, land network 144, voice and data switch 172, and network system 180. Communication services manager 174 stores or retrieves data and information from communication services database 176. Communication services manager 174 may provide requested information to communication services advisor 178.

In one embodiment, communication services advisor 178 is implemented as a real advisor. In an example, a real advisor is a human being in verbal communication with a user or subscriber (e.g., a client) in MVCU 110 via telematics unit 120. In another embodiment, communication services advisor 178 is implemented as a virtual advisor. In an example, a virtual advisor is implemented as a synthesized voice interface responding to requests from telematics unit 120 in MVCU 110.

Communication services advisor 178 provides services to telematics unit 120 in MVCU 110. Services provided by communication services advisor 178 include enrollment services, navigation assistance, real-time traffic advisories, directory assistance, roadside assistance, business or residential assistance, information services assistance, emergency assistance, automated vehicle diagnostic function, and communications assistance. Communication services advisor 178 communicate with telematics unit 120 in MVCU 110 through wireless carrier system 140, communication network 142, and land network 144 using voice transmissions, or through communication services manager 174 and switch 172 using data transmissions. Switch 172 selects between voice transmissions and data transmissions.

In operation, an incoming call is routed to telematics unit 120 within mobile vehicle 110 from call center 170. In one embodiment, the call is routed to telematics unit 120 from call center 170 via land network 144, communication network 142, and wireless carrier system 140. In another embodiment, an outbound communication is routed to telematics unit 120 from call center 170 via land network 144, communication network 142, wireless carrier system 140, and satellite broadcast system 146. In this embodiment, an inbound communication is routed to call center 170 from telematics unit 120 via wireless carrier system 140, communication network 142, and land network 144.

FIG. 2 is a schematic diagram of a system 200 for controlling performance of a vehicle. System 200 is shown installed in a vehicle 210 (e.g., an automobile). System 200 includes a controller 220 bilaterally linked between a communications network and the telematics device 120, which has been described previously. Controller 220 includes a digital microprocessor 222 programmed to process a plurality of input signals from a sensor array 230 and the telematics device 120 as well as to perform determinations. Controller 220 generates one or more output signals for adjusting at least one vehicle function of a vehicle engine 240, transmission 250, exhaust 260, and/or other well known vehicle (sub)systems not shown. The vehicle functions include, but are not limited to, valve timing, ignition characteristics, air charge characteristics, air flow rate, exhaust gas recirculation, top dead center piston position, bottom dead center piston position, cooling efficiency, and torque sensor output. The adjustment of vehicle function(s) may, in turn, advantageously have a direct effect on one or more vehicle performance factors. The vehicle performance factors include, but are not limited to, driver feel, fuel economy, engine temperature, engine speed, engine torque, engine horsepower, engine wear, and vehicle emissions.

Those skilled in the art will recognize that the vehicle functions and vehicle performance factors are not limited to the examples provided herein. The inventors contemplate numerous adjustments of vehicle functions that may advantageously affect vehicle performance. Numerous such functions are known in the art and, therefore, fall within the scope of the present invention.

The methods, algorithms, and determinations (e.g., calculations and estimations) of the presently preferred embodiments, including those based on equations or value tables, may be performed by a device such as the microprocessor 222. The programs, value tables, and equations associated with the embodiments of the present invention may be programmed or read into a storage portion 224 (e.g., ROM, EEPROM, RAM, flash memory, hard drive, and the like) thereby allowing the microprocessor 222 to perform determinations. Furthermore, the values, parameters, and other data may be stored as required in the storage portion 224. Analog signal processing may be provided for some or all of the controller 220 input signals. For example, the signals from the sensor array 230 may be low-pass filtered through analog low-pass filter(s) to reduce signal noise.

Sensor array 230 may receive various digital/discrete and/or analog/continuous signals from numerous sensors positioned about the vehicle. In one embodiment, the sensors may include those sensing a wide variety of vehicle conditions including, but not limited to, engine and transmission (temperature and function), oil (temperature and viscosity), cooling fluid temperatures, and ambient condition factors (e.g., temperature, relative humidity, absolute humidity, dew point temperature, actual and saturation vapor pressure, and barometric pressure). The signals from the sensors may be buffered in a manner known in the art to remove unwanted noise. Furthermore, the signals may comprise a pulse train having pulse timing, of which the type and decoding are well known in the art.

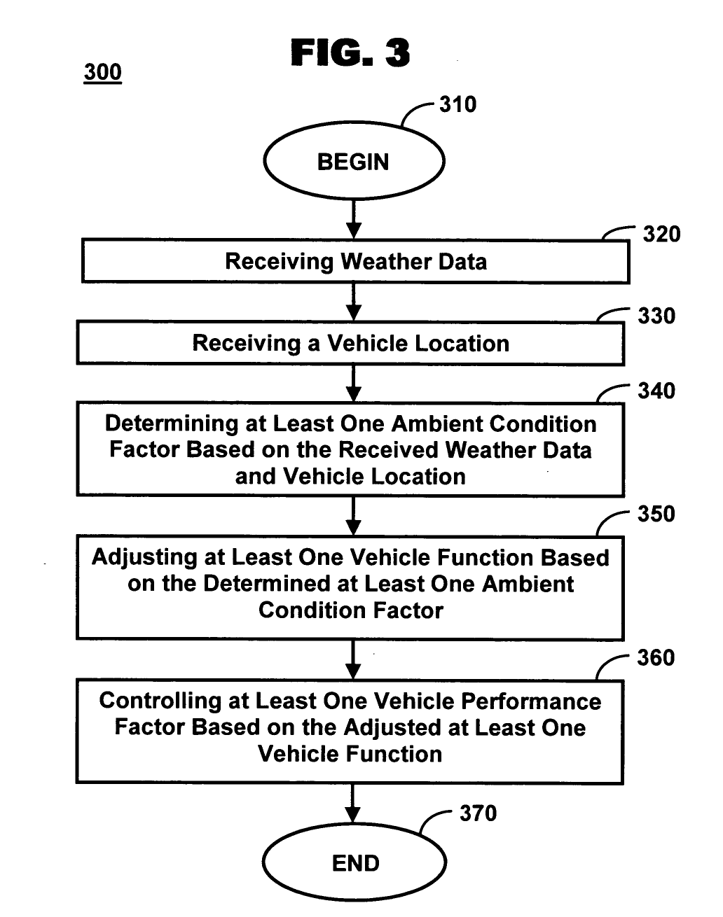

FIG. 3 is a flow diagram of a method of controlling performance of a vehicle. In FIG. 3, method 300 may utilize one or more systems and concepts detailed in FIGS. 1 and 2 and their corresponding descriptions above. The present invention may also take the form of a computer usable medium including a program for configuring an electronic module within a vehicle. The program stored in the computer usable medium includes computer program code for executing the method steps described in FIG. 3.

In FIG. 3, the method 300 begins at step 310.

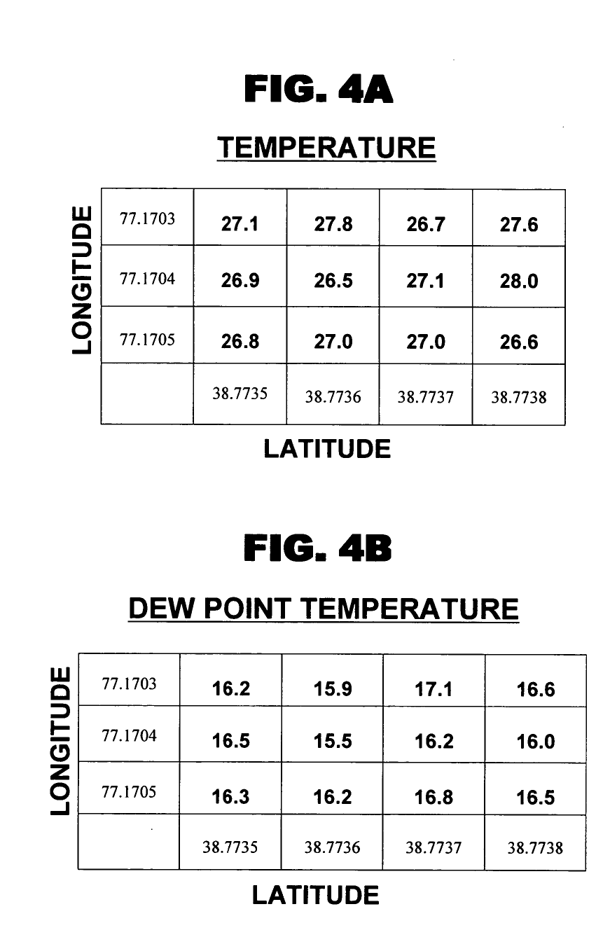

At step 320, weather data is received. The weather data may includes variables such as, for example, temperature, relative humidity, absolute humidity, dew point temperature, barometric pressure, and the like. The weather data, exemplary in this case, may be arranged in a matrix format (e.g., spreadsheet, look-up table, and the like), as shown in FIGS. 4A and 4B, wherein a given weather data variable includes a reading for a given latitude (or range of latitudes) and a given longitude (or range of longitudes). Telematics unit 120 may receive the weather data via a transmission provided by the call center 170 and/or another entity. The received weather data may then be communicated from the telematics unit 120 to the controller 220 for access by the microprocessor 222. Optionally, the received weather data may be stored in the storage portion 224. The weather data may be provided to the call center 170 from various sources known in the art (e.g., a meteorological service).

At step 330, a vehicle location is received. The geographic location of the vehicle may be received from the GPS unit 126. The vehicle location may be expressed as two numbers corresponding to a latitude and longitude coordinate system (i.e., each number having degrees, minutes, and seconds expressed in either decimal or sexagesimal format). In the first embodiment, the vehicle location may be transmitted from the telematics unit 120 to the call center 170. In the second embodiment, the vehicle location may be communicated to the controller 220 for access by the microprocessor 222. Optionally, the determined vehicle location may be stored in the storage portion 224.

At step 340, at least one ambient condition factor is determined based on the received weather information and vehicle location. The ambient condition factors include, but are not limited to, temperature, relative humidity, absolute humidity, dew point temperature, barometric pressure, and the like. Determining a given ambient condition factor may include looking up weather data specific for the determined vehicle location. For example, as shown in FIGS. 4A and 4B, if the determined vehicle location latitude and longitude is 38.7735 and 77.1703, respectively, finding those coordinates on the look-up table reveals a temperature of approximately 27.1° C. (FIG. 4A) and a dew point temperature of approximately 16.2° C. (FIG. 4B). A common psychometric chart may then be used to determine a relative humidity of approximately 50% for that given temperature and dew point temperature. As such, the vehicle location may be used to directly determine certain ambient condition factors, which can then be used to calculate other factors using known mathematical relationships (e.g., equations) therebetween. Likewise, some ambient condition factors may be determined by the relationship: relative humidity=(actual vapor pressure)/(saturation vapor pressure)×100%, wherein actual vapor pressure is a measurement of the amount of water vapor in a volume of air and increases as the amount of water vapor increases, and saturation vapor pressure is a function of dewpoint temperature. The use of charts and/or equations reduces the number of look-up tables required, but typically at a cost of increased processing time and/or power. In addition, the use of increasing latitude and longitude ranges may be utilized (i.e., instead of exact points) to reduce the size of a given look-up table, but typically at a cost of accuracy of the determined ambient condition factor.

The look-up tables may be updated regularly (e.g., every few minutes, every hour, etc.) using real-time weather data thereby providing more accurate determinations of ambient condition factors. Alternatively, the ambient condition factors may be based on 1) forecasted weather data and/or 2) averaged weather data between known real-time points (i.e., using one or more appropriate mathematical algorithms). This alternative may be appropriate in situations, for example, where real-time weather data at every vehicle location is unavailable.

In the first embodiment, the ambient condition factor(s) may be determined at the call center 170. This may reduce the following: 1) the burden placed on microprocessor 222 in terms of performing calculations; 2) the burden placed on the storage portion 224 in terms of storing various look-up tables and/or equations; and 3) the burden of constantly transmitting updated look-up tables and/or equations to the telematics unit 120. Once the required ambient condition factor(s) have been determined at the call center 170, it may then be transmitted to the telematics unit 120.

In the second embodiment, the ambient condition factor(s) may be determined by the onboard microprocessor 222. This embodiment may require additional processing power/time, storage space, and/or data transmission for the vehicle 210. However, this embodiment may reduce the required frequency of communications between the telematics unit 120 and the call center 170 as the vehicle 210 is not dependent upon the call center 170 for constant determinations of the ambient condition factor(s). Those skilled in the art will recognize that the ambient condition factor(s) may be determined using a hybrid of the discussed first and second embodiment or that another strategy may be adapted for such determinations and fall within the scope of the present invention.

At step 350, at least one vehicle function is adjusted based on the determined at least one ambient condition factor. Controller 220 generates one or more output signals for adjusting at least one vehicle function of a vehicle engine 240, transmission 250, exhaust 260, and/or other well known vehicle (sub-)systems not shown. The vehicle functions include, but are not limited to, valve timing, an ignition characteristic, an air-fuel mixture ratio, an air charge characteristic, an air flow rate, exhaust gas recirculation, top dead center piston position, bottom dead center piston position, cooling efficiency, and torque sensor output. The adjustment of vehicle function(s) may, in turn, advantageously have a direct effect on one or more vehicle performance factors. The vehicle performance factors include, but are not limited to driver feel, fuel economy, engine temperature, engine speed, engine torque, engine horsepower, engine wear, and vehicle emissions. Those skilled in the art will recognize that numerous ambient condition factors may dictate adjustments of vehicle functions to ultimately improve the performance factors.

Numerous strategies are known in the art for adjusting vehicle functions based on the determined ambient condition factor(s) thereby advantageously affecting one or more vehicle performance factors. Such strategies may be adapted for use with the present invention. In each instance, the ambient condition factor(s) determined in accordance with the present invention may reduce the need for certain sensors thereby reducing the cost and complexity of the vehicle.

For example, U.S. Pat. No. 6,666,191 to Nakagawa et al. issued on Dec. 23, 2003, discloses a control apparatus for an internal combustion engine. The engine includes an exhaust gas recirculation passage (EGR passage) bypassing all cylinders so as to communicate an intake manifold and an exhaust manifold with each other. The exhaust gas recirculation passage is provided therein with an EGR valve. A predetermined ignition timing is computed and a drive signal is delivered to a spark plug. Intake air from the intake system is adjusted by an electronic throttle, and is then mixed with recirculated exhaust gas adjusted by the EGR valve. Flowing of air fed into the cylinder (combustion chamber) is adjusted by a swirl control valve (SCV), and then, the air flows into the cylinder through a lift timing control type electromagnetically driven intake valve corresponding to an air volume in an engine cylinder upon full opening of a throttle. The air-fuel ratio must be maintained at a constant value in order to efficiently purify exhaust gas from an internal combustion engine, and accordingly the maximum value of the fuel volume must be set to a value corresponding to an air volume in an engine cylinder upon full opening of a throttle. Should a fuel volume greater than the value corresponding to an air volume in an engine cylinder upon full opening of the throttle be fed into the internal combustion engine, fuel would be excessive, resulting in deterioration of HC and CO. However, the air-volume in the engine cylinder upon full opening of the throttle varies, depending upon the atmospheric pressure and the atmospheric temperature or EGR, opening and closing timing of intake and exhaust valves and the like. For example, when the atmospheric pressure lowers and the air volume in an engine cylinder decreases upon full opening of the throttle, fuel becomes excessive if a predetermined fuel volume as mentioned above is fed into the internal combustion engine upon full opening of accelerator, resulting in deterioration of exhaust gas. The strategy disclosed by the '191 patent may include adjustment of the air-fuel ratio with the temperature and humidity ambient condition factors as determined according to the present invention thereby providing improved engine speed, engine torque, and vehicle emissions.

U.S. Pat. No. 6,575,148 to Bhargava et al. issued on Jun. 10, 2003, discloses a humidity compensation system for an internal combustion engine comprising a humidity sensor sensing relative humidity of intake air, a temperature sensor sensing intake air temperature, a pressure sensor sensing intake air pressure, and a control circuit computing a specific humidity (SH) value based on the sensor outputs. The control circuit is configured to compute one or more of an adjusted air-fuel ratio command as a function of SH and a default air-fuel ratio command, an adjusted ignition timing command as a function of SH, engine speed and a default ignition timing command, and an adjusted boost pressure command as a function of SH and a default boost pressure command. The control circuit is operable to control any of fueling, ignition timing and boost pressure based on the corresponding adjusted air-fuel ratio, ignition timing, and boost pressure commands to thereby compensate for humidity effects on engine operation. The strategy disclosed by the '148 patent may include adjustment of the air-fuel ratio and ignition characteristics with the temperature and humidity ambient condition factors as determined according to the present invention thereby providing improved engine speed.

U.S. Pat. No. 6,516,774 to zur Loye et al. issued on Feb. 11, 2003, discloses an engine that includes a premixed charge compression ignition engine capable of operating over a wide load range without the need to vary an intake manifold temperature (IMT) beyond easily achievable or desirable temperature levels. The engine adjusts the start of combustion by adjusting engine speed and torque while delivering a targeted engine horsepower output. Variations in any parameter that affects the start of combustion (SOC) (e.g., IMT, fuel quality, compression ratio variations, humidity variations, etc.) will cause the engine speed/torque to deviate from optimum in response to the request for a horsepower change. For example, if the ambient temperature were considerably lower than nominal conditions, this would result in a delay in SOC and a subsequent reduction in torque for a fixed alternator field current, RPM, and fueling rate. To achieve the desired horsepower at a fixed field current setting, the engine would have to run at a higher engine speed at the cost of increasing the fueling rate (therefore lowering the engine efficiency). The strategy disclosed by the '774 patent may include adjustment of ignition characteristics (e.g., spark timing) of the SOC with the temperature and humidity ambient condition factors as determined according to the present invention thereby providing improved fuel economy, engine speed, engine torque, and engine horsepower.

U.S. Pat. No. 6,259,986 to Kotwicki issued on Jul. 10, 2001, discloses a method for controlling powertrain torque by minimizing the error between the actual powertrain torque (as read by the torque sensor) and the desired powertrain torque (as requested by the vehicle driver). As torque sensors are known to drift under certain conditions, such as high ambient temperature, the output of the torque sensor is adjusted by an offset value. This offset value is determined by reading the torque sensor output when the speed ratio (engine speed/turbine speed) is substantially unity, and the net torque at the torque converter is substantially zero. This adjusted output is then filtered to avoid abrupt fluctuations in the powertrain torque and used to improve powertrain control so that better drive feel and increased fuel economy can be achieved. The strategy disclosed by the '986 patent may include adjustment of the torque sensor output with the temperature ambient condition factor as determined according to the present invention thereby providing improved drive feel and fuel economy.

U.S. Pat. No. 6,182,617 to Bigcharles issued on Feb. 6, 2001, discloses an apparatus for improving the operation of a water-cooled internal combustion engine system. The engine system disclosed in the '617 patent discloses a radiator with interconnecting supply and return passageways, a water circulating pump means, and means to regulate the temperature of the water. The apparatus provides selectable regulation of the cooling water temperature thereby improving at least fuel economy, power output, and heat output into the vehicle cabin. The strategy disclosed by the '617 patent may include improved operation of a water cooling system with the temperature ambient condition factor as determined according to the present invention thereby providing improved fuel economy, engine horsepower, and heat output to a vehicle's interior heater.

U.S. Pat. No. 5,477,827 to Weisman, 11 et al. issued on Dec. 26, 1995, discloses a method and system for engine control. The '827 patent discloses a method, for use in vehicles including a turbocharger, for preventing damage to the turbocharger from turbocharging surging and overspeed during vehicle operation at certain barometric pressures. The method comprises determining a torque modifier based on the barometric pressure associated with the altitude at which the vehicle is being operated, determining a limit torque based on the torque modifier, and limiting the engine turbo speed by limiting fuel delivery to the engine. The '827 patent also discloses a method for preventing damage to engine cylinders and pistons during vehicle operation. The method comprises determining the temperature of air inlet to the engine during combustion, and determining the operating speed of the internal combustion engine. The method also comprises determining an engine torque limit based on the air inlet temperature and the engine speed, and limiting the torque of the engine to the torque limit. The strategy disclosed by the '827 patent may include improved turbocharger, cylinder, and piston operation with the temperature and barometric pressure ambient condition factors as determined according to the present invention thereby limiting damage to various engine components (i.e., improving engine wear).

U.S. Pat. No. 4,009,695 to Ule issued on Mar. 1, 1977, discloses a programmed valve system for an internal combustion engine. The '695 patent discloses a family of embodiments of mechanical, electromechanical, and electronic for the control of intake and exhaust cylinder valves applicable to both spark and compression ignition engines. Electronic control or programming of valve timing, ignition characteristics (e.g., timing and charge quantity), air-charge characteristics (e.g., air-fuel mixture ratio, charge mass, charge density, and air-fuel flow rate), top (and bottom) dead center piston position, and valve timing with respect to their opening and closing times is affected in accordance with predetermined relationships based on data such as inlet air temperature, air density (calculated from barometric pressure), engine temperature, engine speed, vehicle speed, fuel octane, automatic transmission data and operator control commands and operating mode selections is provided. The strategy disclosed by the '695 patent may include valve timing and ignition characteristics with the temperature and barometric pressure ambient condition factors as determined according to the present invention thereby providing improved fuel economy, engine speed, engine torque, engine horsepower, engine wear, and vehicle emissions.

With respect to one embodiment of step 350, the weather data, the vehicle location, the condition factors, and the vehicle function information may be stored in the storage portion 224. The information, along with other information such as feedback data on the performance of the vehicle (e.g., sensor information relating to vehicle performance and other factors), may be useful in determining and fine-tuning optimal vehicle performance for various ambient condition factors. The information may be analyzed by the microprocessor 222 and/or uploaded to the call center 170 via the telematics unit 120 for analysis. The information may also be used to troubleshoot any problems experienced with the vehicle 210. Further, the information may be compiled with that of other vehicles as part of a database thereby facilitating vehicle redesign.

At step 360, at least one vehicle performance factor is controlled based on the adjusted at least one vehicle function. The control may be achieved by employing one or more of the aforementioned strategies based on the adjusted vehicle function(s). The vehicle performance factors include, but are not limited to, driver feel, fuel economy, engine temperature, engine speed, engine torque, engine horsepower, engine wear, and vehicle emissions. The adjusted vehicle function(s) are based on at least one ambient condition factors, which are determined from weather data and vehicle location. The ambient condition factors may be determined without the need for corresponding sensors thereby reducing the cost and complexity of the vehicle. For example, to operate properly, engines require different amounts of fuel based on factors including their engine temperature, ambient condition factors (e.g., ambient air temperature and ambient barometric pressure), RPM, etc. for a given throttle setting. It is desirable to meter and regulate these factors to achieve ideal stoichiometric combustion. When done properly, a high fuel average efficiency and minimized combustion byproducts (both of which are vehicle performance factors) may be achieved. U.S. Pat. No. 6,560,528 to Gitlin et al. issued on May 6, 2003, provides a discussion of ambient air temperature and barometric pressure, engine control, and optimization of vehicle acceleration, fuel economy, engine speed, engine torque, engine horsepower, and vehicle emissions.

The method terminates at step 370.

Those skilled in the art will recognize that other strategies known in the art may be adapted herein for providing advantageous control of vehicle performance factors by adjustment of one or more vehicle functions. The above-described systems and methods for controlling at least one vehicle performance factor are exemplary implementations. The actual implementation may vary from the strategies described and illustrated herein. Moreover, various other improvements and modifications to this invention may occur to those skilled in the art, and those improvements and modifications fall within the scope of this invention as set forth in the claims below.

The present invention may be embodied in other specific forms without departing from its spirit or essential characteristics. The described embodiments are to be considered in all respects only as illustrative and not restrictive.

1. A method of controlling performance of a vehicle, the method comprising;
receiving weather data;
receiving a vehicle location;
determining at least one ambient condition factor based on The received weather data and vehicle location; and
adjusting at least One vehicle function based on the determined at least one ambient condition factor.

2. The method of claim 1, further comprising controlling at least one vehicle performance factor, wherein the at least one vehicle performance factor includes at least one factor selected from a group consisting of driver feel, fuel economy, engine temperature, engine speed, engine torque, engine horsepower, and engine wear.

3. The method of claim 1, wherein the weather data includes at least one of real-time weather data and forecast weather data

4. The method of claim 1, wherein the at least one ambient condition factor is determined by at least one of the vehicle and a call center.

5. The method of claim 1, wherein the at least one ambient condition factor includes at least one of temperature, relative humidity, absolute humidity, dew point temperature, vapor pressure, and barometric pressure.

6. The method of claim 1, wherein the at least one vehicle function includes at least one function selected from a group consisting of valve liming, ignition characteristics, air charge characteristics, air flow rare, exhaust gas recirculation, top dead center piston position, bottom dead center piston position, cooling efficiency, and torque sensor output.

7. The method of claim 1, further comprising:
storing at least one of the weather data, the vehicle location, the at least one ambient condition factor, and the at least one vehicle function.

8. The method of claim 1, wherein the weather data is received by a telematics unit.

9. The method of claim 1, wherein the weather data is transmitted from a call center.

10. A computer usable medium including a program for controlling performance of a vehicle, the computer usable medium comprising:
computer readable program code for receiving weather data;
computer readable program code for receiving a vehicle location;
computer readable program code for determining at least one ambient condition factor based on the received weather data and vehicle location; and
computer readable program code for adjusting at least one vehicle function based on The determined at least one ambient condition factor.

11. The computer usable medium of claim 10, wherein the weather data includes at least one of real-time weather data and forecast weather data.

12. The computer usable medium of claim 10, wherein the at least one ambient condition factor is determined by at least one of the vehicle and a call center.

13. The computer usable medium of claim 10, wherein the at least one ambient condition factor includes at least one of temperature, relative humidity, absolute humidity, dew point temperature, vapor pressure, and barometric pressure.

14. The computer usable medium of claim 10, wherein the at least one vehicle function includes at least one function selected from a group consisting of valve timing, ignition characteristics, air charge characteristics, air flow rate, exhaust gas recirculation, top dead center piston position, bottom dead center piston position, cooling efficiency, and torque sensor output.

15. The computer usable medium of claim 10, further comprising:
computer readable program code for storing at least one of the weather data, The vehicle location, the at least one ambient condition factor, and the at least one vehicle function.

16. The computer usable medium of claim 10, wherein the weather data is received by a telematics unit.

17. The computer usable medium of claim 10, wherein the weather data is transmitted from a call center.

18. A system for controlling performance of a vehicle, the system comprising:
means for receiving weather data;
means for receiving a vehicle location;
means for determining at least one ambient condition factor based on the received weather data and vehicle location; and
means for adjusting at least one vehicle function based on the determined at least one ambient condition actor.

19. The system of claim 18, further comprising;
means for controlling at least one vehicle performance factor based on the adjusted at least one vehicle function.

20. The system of claim 18, further comprising:
means for storing at least one of the weather data, the vehicle location, the at least one ambient condition factor, and the at least one vehicle function.
